(19) United States
(12) Patent Application Publication
(10) Pub. No.: US 2007/0118684 A1
(43) Pub. Date: May 24, 2007

(54) Operation method of embedded system

(75) Inventors: Jun-Ren Huang, Tu-Cheng, CA (US); Ming-Chung Wang, Tu-Cheng, CA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO.,LTD., Tu-Cheng City (TW)

(21) Appl. No.: 11/589,431

(22) Filed: Oct. 30, 2006

(30) Foreign Application Priority Data
Nov. 18, 2005 (TW) 94140633

(51) Int. Cl. G06F 12/00

(52) U.S. Cl. 711/103; 711/170

(57) ABSTRACT

An operation method of an embedded system, comprising steps of: providing a controller, a volatile random access memory (VRAM), and a non-volatile random access memory (NVRAM); adding a sub-grouping tag to each value of configuration data of the embedded system; grouping the added sub-grouping tags into a grouping tag; saving the grouping tags, sub-grouping tags, and values of the configuration data in the NVRAM; receiving a setting instruction from a service provider; searching for the grouping tag saved in the NVRAM to detect whether the setting instruction comprises the grouping tag of the configuration data; copying the configuration data to the VRAM, if the setting instruction comprises the grouping tag of the configuration data; and loading the configuration data to the controller.

### BACKGROUND

1. Field of the Invention

The invention relates to an operation method, and particularly to operation method of an embedded system.

2. Related Art

With rapid development of wireless network communication, embedded systems are popularly used in products such as mobile phones, modems, and gateways.

An typical embedded system includes a controller, a non-volatile random access memory (NVRAM) for saving firmware, a volatile random access memory (VRAM) for saving programs, and an embedded operation system.

When the embedded system operates, the VRAM firstly reads all configuration data from the NVRAM, the controller then selects and loads necessary configuration data. However, the necessary configuration data constitute a small portion of all configuration data, but the VRAM must read all configuration data from the NVRAM, which is quite time-consuming.

### SUMMARY

An operation method of an embedded system, comprising steps of: providing a controller, a volatile random access memory (VRAM), and a non-volatile random access memory (NVRAM); adding a sub-grouping tag to each value of configuration data of the embedded system; grouping the added sub-grouping tags into a grouping tag; saving the grouping tags, sub-grouping tags, and values of the configuration data in the NVRAM; receiving a setting instruction from a service provider; searching for the grouping tag saved in the NVRAM to detect whether the setting instruction comprises the grouping tag of the configuration data; copying the configuration data to the VRAM, if the setting instruction comprises the grouping tag of the configuration data; and loading the configuration data to the controller.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic diagram illustrating an embedded system of an exemplary embodiment of the present invention;

FIG. 2 is a flowchart of an operation method of the embedded system of a further exemplary embodiment of the present invention; and

FIG. 3 is a flowchart of an operation method of the embedded system of a still further exemplary embodiment of the present invention.

### DETAILED DESCRIPTION OF THE EMBODIMENTS

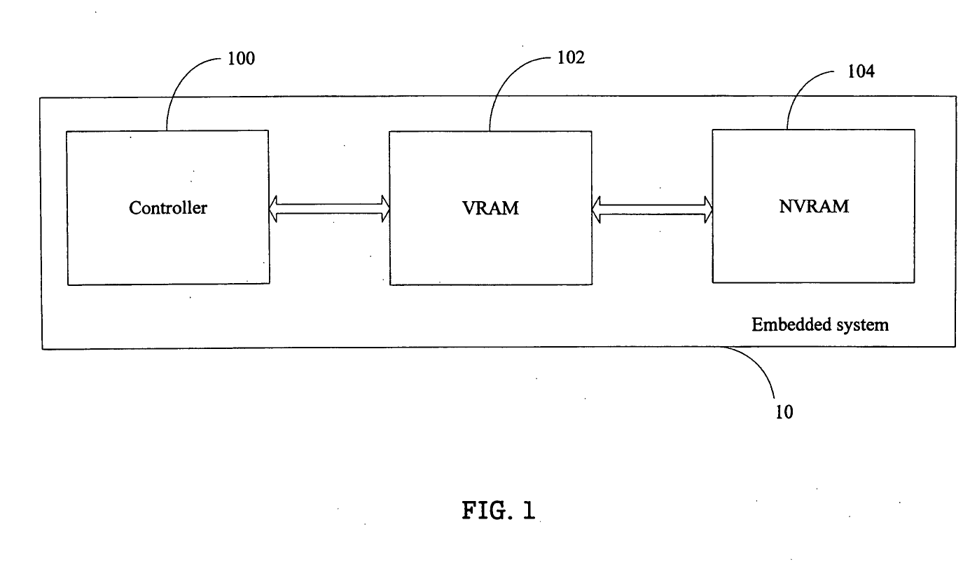

FIG. 1 is a schematic diagram illustrating an embedded system of an exemplary embodiment of the present invention. The embedded system 10 includes a controller 100, a volatile random access memory (VRAM) 102, and a non-volatile random memory (NVRAM) 104. The controller 100 saves all configuration data (shown the Table 1) in the NVRAM 104, and the VRAM copies the necessary configuration data from the NVRAM 104 when the embedded system 10 operates. In the exemplary embodiment, the controller 100 is a central processing unit (CPU), and the VRAM 102 is also a dynamic random access memory.

As shown in Table 1 below, Table 1 is an exemplary table for saving configuration data in the NVRAM 104. In the exemplary embodiment, the configuration data include grouping tags, sub-grouping tags, and values of the configuration data. Several added sub-grouping tags are grouped into a grouping tag. For example, the configuration data saved in the NVRAM 104 are parameters related to connection modes between the embedded system 10 and the Internet. In the exemplary embodiment, the connection modes include point to point protocol over Ethernet (PPPOE) mode and dynamic host configuration protocol (DHCP) mode. Both the PPPoE mode and the DHCP mode include a plurality of parameters, such as user names, passwords, and so on. As shown in Table 1, in PPPoE mode, the user name is “123”, the password is “456”, that “123” and “456” represent values of the configuration data, “name” and “password” are sub-grouping tags thereof, and “PPPoE” is a grouping tag thereof.

TABLE 1

PPPoE
Name = 123
Password = 456
DHCP
Name = 789
Password = 10112

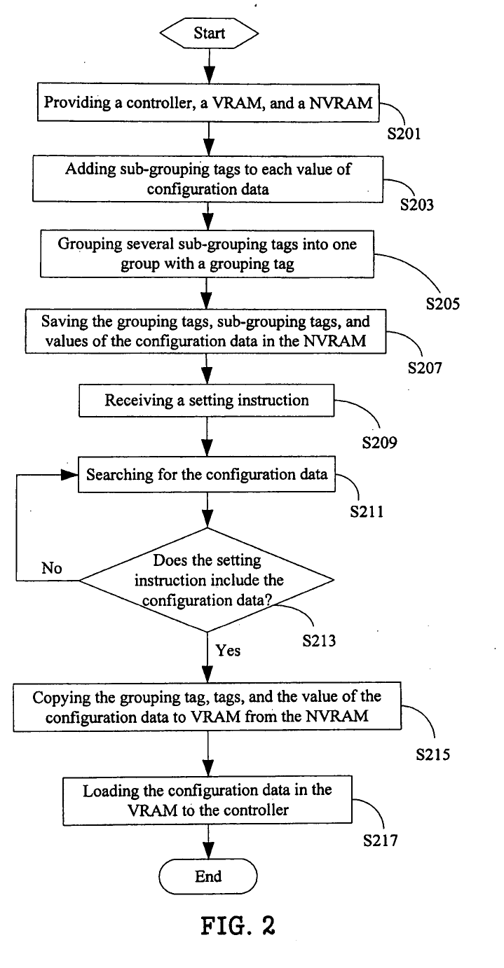

FIG. 2 is a flowchart of an operation method of the embedded system of a further exemplary embodiment of the present invention.

In step S201, the controller 100, the VRAM 102, and the NVRAM 104 are provided.

In step S203, each value of configuration data of the embedded system 10 is assigned a sub-grouping tag.

In step S205, several assigned sub-grouping tags are grouped into a grouping tag.

In step S207, the grouping tag, the sub-grouping tags, and the values of configuration data are saved in the NVRAM 104.

In step S209, the embedded system 10 receives a setting instruction from a service provider (not shown). In the exemplary embodiment, one instruction corresponds to one grouping tag of the configuration data.

In step S211, the controller 100 searches for the configuration data in the NVRAM 104. In the exemplary embodiment, the controller 100 searches for the grouping tag of the configuration data.

In step S213, the controller 100 detects whether the setting instruction includes the configuration data. In the exemplary embodiment, the controller 10 detects whether the setting instruction includes the configuration data by detecting whether the setting instruction includes the grouping tag of the configuration data. If yes, the process proceeds to step S215. If not, the process returns to step S211.

In step S215, the VRAM 102 copies the grouping tag, the sub-grouping tags, and the values of the configuration data from the NVRAM 104. In the exemplary embodiment, the VRAM 102 copies the configuration data via a pointer.

In step S217, the controller 100 loads the configuration data in the VRAM 102.

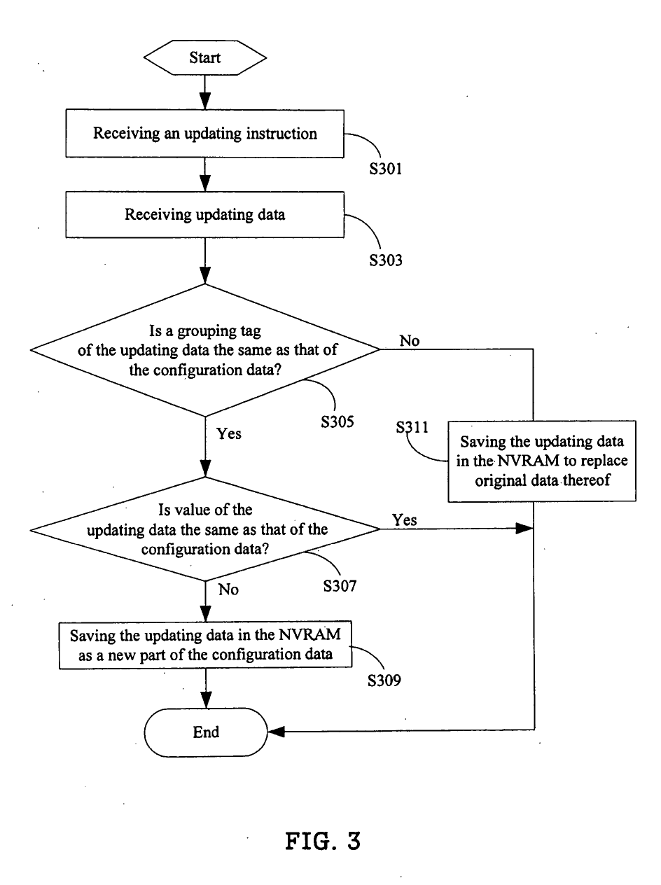

FIG. 3 is a flowchart of an operation method of the embedded system of a still further exemplary embodiment of the present invention.

In step S301, the embedded system 10 receives an update instruction from the service provider (not shown) when the embedded device is working after the step S217 shown in FIG. 2.

In step S303, the embedded system 10 receives updating data after receiving the update instruction. In the exemplary embodiment, the updating data include grouping tags, sub-grouping tags, and values of configuration data, in which the sub-grouping tags are grouped into a grouping tag. Typically, one update instruction corresponds with one grouping tag.

In step S305, the controller 100 determines whether the grouping tag of the updating data is the same as that in the NVRAM 104. If the grouping tag of the updating data is the same as that in the NVRAM 104, the process proceeds to step S307. If the grouping tag of the updating data is not the same as that saving in the NVRAM 104, the process proceeds to step S311.

In step S307, the controller 100 determines whether the values of the updating data are the same as that of the configuration data. If yes, the process proceeds to step S309; if not, the process proceeds to step S311.

In step S309, the controller 100 saves the values of the updating data to the grouping tag of the configuration data in the NVRAM 104, to replace original data thereof.

In step S311, the controller 100 saves the updating data in the NVRAM 104 with the grouping tag of the updating data. In the exemplary embodiment, the updating data is a new part of the configuration data.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

I claim:

1. An operation method of an embedded system, comprising steps of:
providing a controller, a volatile random access memory (VRAM), and a non-volatile random access memory (NVRAM);
adding a sub-grouping tag to each value of configuration data of the embedded system;
grouping the added sub-grouping tags into a grouping tag;
saving the grouping tags, sub-grouping tags, and values of the configuration data in the NVRAM;
receiving an instruction from a service provider;
searching for the grouping tag saved in the NVRAM to detect whether the instruction comprises the grouping tag of the configuration data;
copying the configuration data to the VRAM, if the instruction comprises the grouping tag of the configuration data; and
loading the configuration data to the controller.

2. The method as claimed in claim 1, further comprising searching for the grouping tag continually, if the instruction does not comprise the grouping tag of the configuration data.

3. The method as claimed in claim 1, wherein the step of copying the configuration data to the VRAM if the instruction comprises the grouping tag of the configuration data comprises copying the configuration data via a pointer.

4. The method as claimed in claim 1, further comprising receiving an update instruction after loading the configuration data to the controller.

5. The method as claimed in claim 4, further comprising receiving updating data after receiving the update instruction.

6. The method as claimed in claim 5, wherein the updating data comprises grouping tags, sub-grouping tags, and values of configuration data, one grouping tag corresponding with one update instruction.

7. The method as claimed in claim 6, further comprising detecting whether the grouping tag of the updating data is the same as that of the configuration data.

8. The method as claimed in claim 7, further comprising saving the updating data with the grouping tag in the NVRAM if the grouping tag of the updating data is not the same as that of the configuration data.

9. The method as claimed in claim 6, further comprising detecting whether the value of the updating data is the same as that of the configuration data if the grouping tag of the updating data is the same as that of the configuration data.

10. The method as claimed in claim 9, further comprising saving the updating data with the grouping tag of the configuration data to replace original data thereof if the grouping tag of the updating data is the same as that of the configuration data.

11. A method of operating an embedded system, comprising steps of:
assigning a sub-grouping tag to each of a plurality of values of configuration data of an embedded system;
grouping said assigned sub-grouping tags for said plurality of values of said configuration data;
assigning a grouping tag for each group comprising said grouped sub-grouping tags;
saving said assigned grouping tags and sub-grouping tags, and said plurality of values of said configuration data, correspondingly;
receiving an instruction to operate said embedded system; and
processing corresponding values of said configuration data based on said assigned grouping tags and sub-grouping tags available in said instruction.

12. The method as claimed in claim 11, wherein said instruction comprises a setting instruction and an update instruction.

13. A method of operating an embedded system, comprising steps of:
assigning a sub-grouping tag to each of a plurality of values of configuration data of an embedded system;
grouping said assigned sub-grouping tags for said plurality of values of said configuration data of said embedded system;
assigning a grouping tag for each group comprising said grouped sub-grouping tags;
saving said assigned grouping tags and sub-grouping tags, and said plurality of values of said configuration data, correspondingly;
loading corresponding values of said configuration data based on said assigned grouping tags and sub-grouping tags when an instruction is received to operate said embedded system and indicates said assigned grouping tags and sub-grouping tags.

14. The method as claimed in claim 13, wherein said instruction comprises a setting instruction and an update instruction.
